(19) United States
(12) Patent Application Publication
(10) Pub. No.: US 2025/0335633 A1
(43) Pub. Date: Oct. 30, 2025

(54) IMAGE PROCESSING APPARATUS

(71) Applicant: KYOCERA Document Solutions Inc., Osaka (JP)

(72) Inventors: Koji SATO, Osaka (JP); Ryota OKUI, Osaka (JP); Hiroshi SUGIHARA, Osaka (JP); Kota KAMISONO, Osaka (JP)

(73) Assignee: KYOCERA Document Solutions Inc., Osaka (JP)

(21) Appl. No.: 19/185,372

(22) Filed: Apr. 22, 2025

(30) Foreign Application Priority Data
Apr. 24, 2024 (JP) 2024-070621

(51) Int. Cl. G06F 21/62; G06F 3/04842; G06V 10/25; G06V 30/10

(52) U.S. Cl. CPC G06F 21/6254; G06F 3/04842; G06V 10/25; G06V 30/10

(57) ABSTRACT

An image processing apparatus includes an image reading portion, a control portion, and an operation/display portion. The operation/display portion accepts an information selection operation and a method selection operation. When generating the output image data, the control portion extracts text data by an OCR process on the original image data, extracts personal information from the text data, recognizes as a target region a region of the original image data that contains the personal information selected by the information selection operation, and anonymizes the personal information in the target region by the method selected by the method selection operation.

### INCORPORATION BY REFERENCE

This application is based on and claims the benefit of priority from Japanese Patent Application No. 2024-070621 filed on Apr. 24, 2024, the contents of which are hereby incorporated by reference.

### BACKGROUND

The present disclosure relates to image processing apparatuses.

Some known image processing apparatuses read documents containing personal information and perform an anonymizing process (in other words, concealing process) on a region corresponding to the personal information in the image data acquired by reading the documents.

### SUMMARY

According to ne aspect of the present disclosure, an image processing apparatus includes an image reading portion, a control portion, and an operation/display portion. The image reading portion reads a document containing personal information. The control portion performs an anonymizing process on original image data acquired through the reading of the document by the image reading portion and thereby generates output image data in which the personal information is anonymized. The operation/display portion displays information and accepts an operation The operation/display portion accepts an information selection operation for selecting the personal information to be anonymized and a method selection operation for selecting an anonymizing method for the personal information. When generating the output image data, the control portion extracts text data by an OCR process on the original image data, extracts the personal information from the text data, recognizes as a target region a region of the original image data that contains the personal information selected by the information selection operation, and performs as the anonymizing process a process of anonymizing the personal information in the target region by the method selected by the method selection operation.

### BRIEF DESCRIPTION OF THE DRAWINGS

FIG. 1 is a schematic diagram of a multifunction peripheral according to one embodiment.

FIG. 2 is a block diagram of the multifunction peripheral according to the embodiment.

FIG. 3 is a diagram schematically showing one example of a document (personal information) that can be the target of reading on the multifunction peripheral according to the embodiment.

FIG. 4 is a flow chart showing a procedure for an anonymizing job performed on the multifunction peripheral according to the embodiment.

FIG. 5 is a diagram showing a setting screen displayed when an information selection operation is accepted on the multifunction peripheral according to the embodiment.

FIG. 6 is a diagram showing a setting screen displayed when a method selection operation is accepted on the multifunction peripheral according to the embodiment.

FIG. 7 is a flow chart showing a procedure of a personal information extraction process performed on the multifunction peripheral according to the embodiment.

FIG. 8 is a diagram illustrating an anonymizing process (blacking-out) performed on the multifunction peripheral according to the embodiment.

FIG. 9 is a diagram illustrating an anonymizing process (initial character extraction and labeling) performed on the multifunction peripheral according to the embodiment.

FIG. 10 is a diagram illustrating a first edit operation accepted on the multifunction peripheral according to the embodiment.

FIG. 11 is a diagram illustrating a second edit operation accepted on the multifunction peripheral according to the embodiment.

FIG. 12 is a diagram illustrating a display switch operation accepted on the multifunction peripheral according to the embodiment.

FIG. 13 is a diagram illustrating a candidate display operation accepted on the multifunction peripheral according to the embodiment.

### DETAILED DESCRIPTION

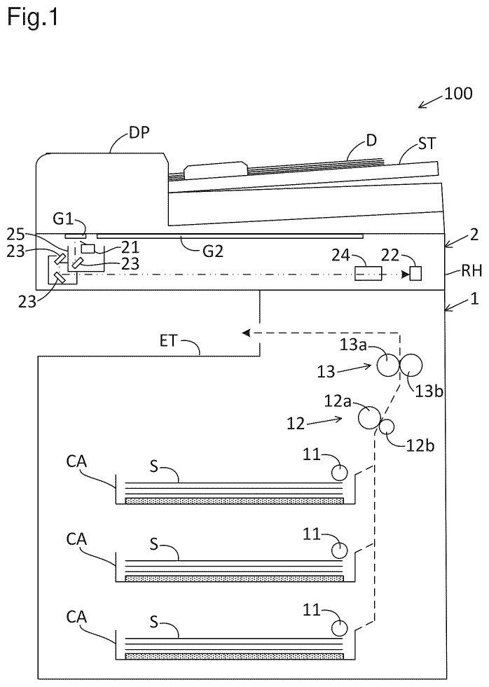

Configuration of a Multifunction Peripheral: With reference to FIGS. 1 to 13, an image processing apparatus according to one embodiment of the present disclosure will be described below taking as an example a multifunction peripheral 100 having a plurality of functions such as scanning, printing, and data transmission.

As shown in FIG. 1, the multifunction peripheral 100 (corresponding to an “image processing apparatus”) includes a printing portion 1. The printing portion 1 constitutes the body of the multifunction peripheral 100. The printing portion 1 prints an image on a sheet S. The printing portion 1 employs an electrophotographic printing process. This however is not meant as any limitation: the printing portion 1 can employ an inkjet printing process.

The printing portion 1 forms an image based on image data fed to the multifunction peripheral 100. The printing portion 1 conveys the sheet S along a sheet conveyance passage. The printing portion 1 prints an image on the sheet S being conveyed. In FIG. 1, the sheet conveyance passage is indicated by a broken line.

The printing portion 1 includes a sheet feed roller 11. The sheet feed roller 11 lies in contact with the sheet S stored in a sheet cassette CA and rotates in that state. Thus the sheet feed roller 11 feeds the sheet S from the sheet cassette CA to the sheet conveyance passage.

The printing portion 1 includes an image forming portion 12. The image forming portion 12 includes a photosensitive drum 12a and a transfer roller 12b. The photosensitive drum 12a carries a toner image on its circumferential surface. The transfer roller 12b stays in pressed contact with the photosensitive drum 12a and forms a transfer nip with the photosensitive drum 12a. The transfer roller 12b rotates together with photosensitive drum 12a. The image forming portion 12, while conveying the sheet S having entered the transfer nip, transfers the toner image to the sheet S.

The image forming portion 12 further includes, though not shown, a charging device, an exposure device, and a developing device. The charging device electrostatically charges the circumferential surface of the photosensitive drum 12a. The exposure device forms an electrostatic latent image on the circumferential surface of the photosensitive drum 12a. The developing device develops the electrostatic latent image on the circumferential surface of photosensitive drum 12a into a toner image.

The printing portion 1 includes a fixing portion 13. The fixing portion 13 includes a heating roller 13a and a pressing roller 13b. The heating roller 13a incorporates a heater (not shown). The pressing roller 13b stays in pressed contact with the heating roller 13a to form a fixing nip with the heating roller 13a. The pressing roller 13b rotates together with the heating roller 13a. The fixing portion 13, while conveying the sheet S having entered the fixing nip, fixes the toner image transferred to the sheet S to the sheet S. The sheet S having left the fixing nip is discharged to a discharge tray ET.

The multifunction peripheral 100 also includes an image reading portion 2. The image reading portion 2 is disposed over the body of the multifunction peripheral 100. In a job involving the reading of a document D, the document D is set on the image reading portion 2. The image reading portion 2 reads the document D set on the image reading portion 2 to generate the image data of the read document D.

The image reading portion 2 includes contact glasses G1 and G2. The contact glasses G1 and G2 are arranged in a housing RH of the image reading portion 2. The housing RH has an opening in its top face. The contact glasses G1 and G2 are fitted in the opening in the top face of the housing RH.

The image reading portion 2 includes a document conveying device DP. The document conveying device DP is fitted to the housing RH. As seen from in front of the multifunction peripheral 100, the document conveying device DP pivots such that a front part of it swings up and down about a rear part of it. The document conveying device DP thus opens and closes with respect to the top face of the housing RH.

The document conveying device DP has a set tray ST on which the document D is set. The document conveying device DP conveys the document D set on the set tray ST onto the contact glass G1.

In a feed-reading mode, the user sets the document D on the set tray ST. The document D automatically conveyed onto the contact glass G1 by the document conveying device DP (in other words, the document D passing over the contact glass G1) is read. On the other hand, in a stationary reading mode, the user sets the document D on the contact glass G2, and the document D on the contact glass G2 is read.

The image reading portion 2 includes a light source 21, an image sensor 22, a mirror 23, and a lens 24. The light source 21, the image sensor 22, the mirror 23, and the lens 24 are arranged inside the housing RH. The image reading portion 2 carries out scanning operation by emitting light from the light source 21 to the contact glass G1 or G2 and performing photoelectric conversion in the image sensor 22.

The light source 21 has a plurality of LED elements. The plurality of LED elements are arrayed in a line along the main scanning direction (the direction perpendicular to the plane of FIG. 1). The image sensor 22 has a plurality of photoelectric conversion elements lined up along the main scanning direction. The mirror 23 reflects light toward the lens 24. The lens 24 collects the light reflected from the mirror 23 and directs it to the image sensor 22.

The light source 21 and the mirror 23 are arranged on a carriage 25 that is movable in the sub (subsidiary) scanning direction (the left-right direction in FIG. 1), which is orthogonal to the main scanning direction. As the carriage 25 moves in the sub scanning direction, the reading line of the image reading portion 2 moves in the sub scanning direction.

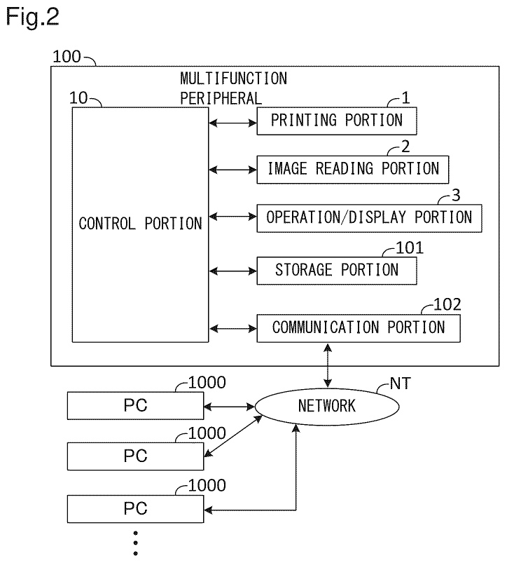

As shown in FIG. 2, the multifunction peripheral 100 includes an operation/display portion 3. The operation/display portion 3 is an operation panel with a touch screen. The operation/display portion 3 displays software buttons, messages, and the like on the touch screen. The operation/display portion 3 also has a plurality of hardware buttons. The operation/display portion 3 accepts operations from the user. Via the operation/display portion 3 the user can make settings for various jobs including an anonymizing job, which will be described later.

The multifunction peripheral 100 includes a control portion 10. The control portion 10 includes a CPU, an ASIC, a memory, and the like. The control portion 10 also includes an image processing circuit. The control portion 10 performs various kinds of image processing on image data. The control portion 10 also controls the printing of an image on the sheet S by the printing portion 1, and controls the reading of the document D by the image reading portion 2.

The control portion 10 also controls the operation/display portion 3. Specifically, the control portion 10 controls display operation on the touch screen. The control portion 10 senses operations on the software buttons and the hardware buttons. Based on the operations that the operation/display portion 3 accepts from the user, the control portion 10 makes settings for a job.

The multifunction peripheral 100 includes a storage portion 101. The storage portion 101 is a non-volatile storage device. U sable as the storage portion 101 is an HDD or an SSD. The storage portion 101 is connected to the control portion 10. The control portion 10 writes information to and reads information from the storage portion 101.

The storage portion 101 previously stores a character recognition program. Based on the character recognition program, the control portion 10 performs a character recognition process such as OCR (optical character recognition). The control portion 10 handles as the target of the character recognition process the image data acquired through the reading of the document D by the image reading portion 2.

The multifunction peripheral 100 includes a communication portion 102. The communication portion 102 is an interface that permits an external device to be connected to the multifunction peripheral 100 so that communication is possible between them. The communication portion 102 includes a communication circuit, a communication memory, a communication connector, and the like. The communication portion 102 is connected to the control portion 10. Using the communication portion 102 the control portion 10 exchanges data with the external device.

The communication portion 102 is connected to the external device across a network NT such as a LAN and the Internet so that communication is possible between them. Though not illustrated, the communication portion 102 can be connected directly to the external device via a communication cable. The external device connected to the communication portion 102 is, for example, a personal computer 1000 (hereinafter “PC 1000”) used by the user of the multifunction peripheral 100. Any external device other than the PC 1000 can be connected to the multifunction peripheral 100 so that communication is possible between them. Connecting the PC 1000 to the multifunction peripheral 100 permits the image data of the document D acquired through the reading of the document D by the image reading portion 2 to be transmitted to the PC 1000. Thus, the image data of the document D can be stored on the PC 1000.

Outline of the Anonymizing Process: The multifunction peripheral 100 has an anonymizing function. In other words, the multifunction peripheral 100 can perform a job related to the anonymizing function (hereinafter “anonymizing job”). In the anonymizing job, a document D containing personal information is read and the image data acquired by reading the document D, that is, original image data, is subjected to an anonymizing process to anonymize the personal information. Thus, output image data is generated in which at least part of the personal information is anonymized. The output image data is image data generated from the original image data, and is image data in which part of the original image data is modified.

Using the anonymizing function permits one to acquire image data (i.e., output image data) resulting from anonymizing at least part of personal information contained in a document D. One can then print on a sheet S an image based on the output image data. One can also transmit the output image data to the PC 1000 to store it on the PC 1000.

A document D containing personal information can be, among many other, a driving license, health insurance card, passport, or medical record (clinical record). Personal information can be, among many other, a personal name, address, telephone number, credit card number, or mail address. In the following description, a document D containing personal information is termed simply as “document D.”

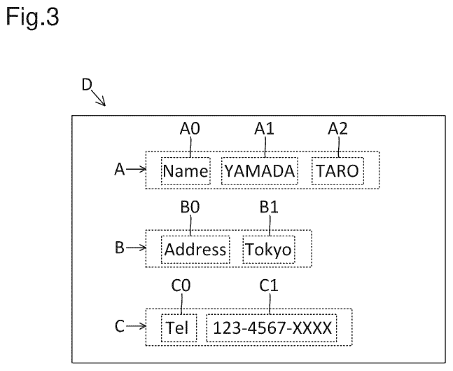

FIG. 3 schematically shows one example of a document D. The document D contains personal information particulars (values of items) and personal information types (names of items) in pairs. For convenience' sake, FIG. 3 shows as personal information particulars a personal name (“Name”), an address (“Address”), and a telephone number (“Tel”).

To perform an anonymizing job, the user sets a document D in the image reading portion 2. In this state the user performs on the operation/display portion 3 a starting operation for the anonymizing job. When the starting operation is performed on the operation/display portion 3, the control portion 10 starts the anonymizing job.

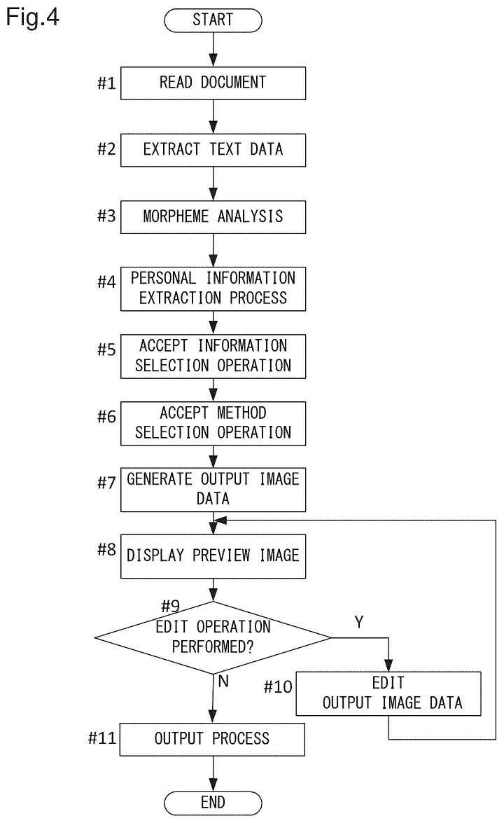

Now, with reference to the flow chart in FIG. 4 the procedure for the anonymizing job will be described. The procedure shown in FIG. 4 starts when the starting operation for the anonymizing job is performed on the operation/display portion 3.

At step #1, the control portion 10 makes the image reading portion 2 read the document D. The image reading portion 2 reads the document D and generates the image data of the read document D. The image data generated here is original image data. The control portion 10 acquires the original image data obtained through the reading of the document D by the image reading portion 2.

At Step #2, the control portion 10 performs an OCR process on the original image data to extract text data from the original image data. Thus the control portion 10 recognizes character strings in the original image data. The control portion 10 also recognizes the positions (i.e., coordinates) of character regions containing the character strings in the original image data. If the document D shown in FIG. 3 is the target of the anonymizing job, character strings A, B, and C are extracted as text data.

At Step #3, the control portion 10 performs morpheme analysis on the text data extracted from the original image data. That is, the control portion 10 segmentizes the text data extracted from the original image data in units of words. If the document D shown in FIG. 3 is the target of the anonymizing job, character string A is segmentized into character strings A0, A1, and A2, each as a word; character string B is segmentized into character strings B0 and B1, each as a word; character string C is segmentized into character strings C0 and C1, each as a word. Moreover, by performing morpheme analysis on the text data extracted from the original image data, the control portion 10 discriminates the part-of-speech of each word (i.e., segmentized character string) in the text data.

At Step #4, the control portion 10 performs a personal information extraction process. Specifically, for each word in the text data extracted from the original image data, the control portion 10 checks whether it is personal information to extract personal information from the text data. In other words, the control portion 10 extracts proper nouns from the text data. The personal information extraction process will be described in detail later.

At Step #5, the control portion 10 makes the operation/display portion 3 accept an information selection operation. The information selection operation is an operation to select personal information to be anonymized. The control portion 10 takes the personal information selected by the information selection operation as the target of the anonymizing process. The information selection operation can be accepted before the start of the anonymizing job (i.e., before the reading of the document D).

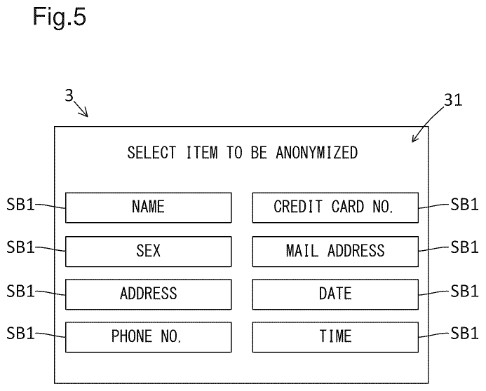

The operation/display portion 3 displays a setting screen 31 as shown in FIG. 5 to accept an information selection operation from the user. On the setting screen 31 are arranged a plurality of information selection buttons SB 1 (software buttons) corresponding to a plurality of types of personal information respectively. The operation/display portion 3 accepts as the information selection operation a touch operation on one of the information selection buttons SB1.

The control portion 10 senses the information selection button SB1 on which the information selection operation has been made (i.e., the touched information selection button SB1) and takes the personal information corresponding to the sensed information selection button SB 1 as the target of the anonymizing process. For example, if an information selection operation on the information selection button SB1 marked “NAME” is sensed, the control portion 10 recognizes the personal information corresponding to the information selection button SB1 marked “NAME” as the information to be anonymized.

At Step #6, the control portion 10 makes the operation/display portion 3 accept a method selection operation. The method selection operation is an operation to select a method of anonymizing personal information. The control portion 10 recognizes the method selected by the method selection operation as the anonymizing method to be performed. For example, different anonymizing methods are made available such as blacking-out, initial character extraction, and labeling so that one of the three anonymizing methods can be selected. The number of available anonymizing methods can be two, or four or more.

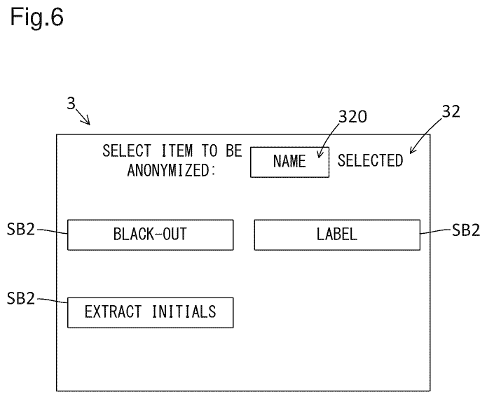

The operation/display portion 3 displays a setting screen 32 as shown in FIG. 6 to accept a method selection operation from the user. On the setting screen 32 are arranged a plurality of method selection buttons SB2 (software buttons) corresponding to a plurality of anonymizing methods respectively. The operation/display portion 3 accepts as the method selection operation a touch operation on one of the method selection buttons SB2.

The control portion 10 senses the method selection button SB2 on which the method selection operation has been made (i.e., the touched method selection button SB2) and recognizes the method corresponding to the sensed method selection button SB2 as the anonymizing method to be performed. For example, if a method selection operation on the method selection button SB2 marked “BLACKING-OUT” is sensed, the control portion 10 recognizes blacking-out as the anonymizing method to be performed.

By the information selection operation the user can select a plurality of types of personal information as information to be anonymized. When a plurality of types of personal information are selected as information to be anonymized, for each of the plurality of types of personal information selected, an anonymizing method can be selected. With this configuration the operation/display portion 3 accepts a method selection operation for each of the plurality of types of personal information selected by the information selection operation. On the setting screen 32 (see FIG. 6) for accepting a method selection operation, the type of personal information (i.e., item) that is targeted is displayed in a field 320.

At Step #7, the control portion 10 performs the anonymizing process on original image data. Thereby the control portion 10 generates output image data in which at least part of personal information is anonymized. The anonymizing process is a process whereby personal information in a target region is anonymized.

When generating the output image data, the control portion 10 recognizes as the target region a region in the original image data that contains the personal information selected by the information selection operation. That is, the control portion 10 recognizes as the target region a region in the original image data that contains personal information to be anonymized. For example, if name is selected by the information selection operation, the control portion 10 recognize as the target region a region that contains personal information corresponding to a personal name.

As a modified example, .previously defined personal information can be set by default as information to be anonymized. In that case, even if this personal information is not selected by the information selection operation, the control portion 10 takes that personal information as the target to be anonymized.

After recognizing the target region in the original image data, the control portion 10 anonymizes the personal information in the target region by the method selected by the method selection operation. That is, the control portion 10 performs the anonymizing process on the personal information in the target region. The anonymizing process will be described in detail later.

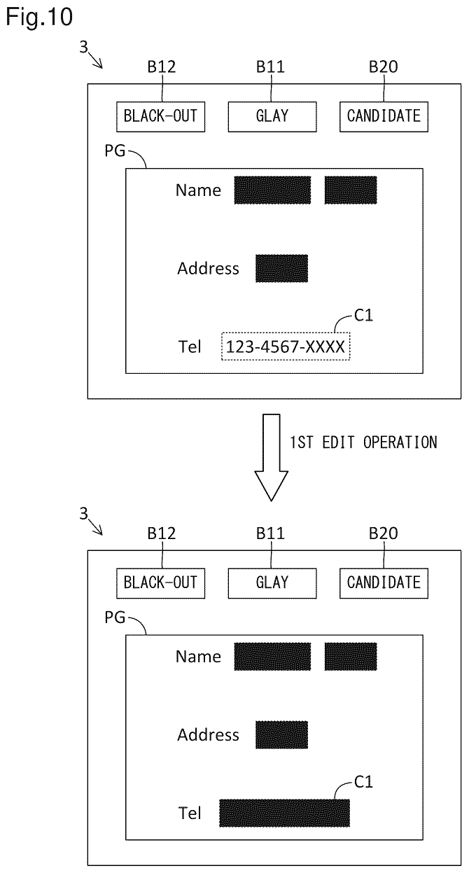

At Step #8, the control portion 10 generates a preview image PG (see FIGS. 10 to 13) corresponding to the output image data and makes the operation/display portion 3 display it. The operation/display portion 3 displays, out of the preview image PG, a region containing the personal information on an enlarged scale. A configuration is possible that allows the user to select out of the preview image PG a part to be displayed on an enlarged scale. In that case, the operation/display portion 3 displays, out of the preview image PG, the part specified by the user on an enlarged scale.

At Step #9, the control portion 10 makes the operation/display portion 3 accept an edit operation to edit the output image data. Meanwhile, the operation/display portion 3 continues displaying the preview image PG. That is, when accepting an edit operation, the operation/display portion 3 displays the preview image PG. While the preview image PG is being displayed, the control portion 10 checks whether an edit operation has been performed. The editing of the output image data will be described in detail later.

If the control portion 10 judges that the edit operation has been performed, the control portion 10 proceeds to Step #10. At Step #10, based on the edit operation that the operation/display portion 3 has accepted, the control portion 10 edits the output image data. In other words, based on the edit operation that the operation/display portion 3 has accepted, the control portion 10 generates new output image data.

The control portion 10 then generates a new preview image PG corresponding to the new output image data and makes the operation/display portion 3 display the new preview image PG in place of the existing preview image PG. The control portion 10 then makes the operation/display portion 3 once again accept an edit operation to edit the output image data. That is, a transition is made from Step #10 to Step #8.

If at Step #9 the control portion 10 judges that no edit operation has been performed, the control portion 10 proceeds to Step #11. In other words, if the control portion 10 judges that an operation to request continuation of a job without performing an edit operation is made on the operation/display portion 3, the control portion 10 proceeds to Step #11. After the edit operation (i.e., after proceeding from Step #10 to Step #8), if no additional edit operation is needed, an operation to request continuation of a job without performing an edit operation is made on the operation/display portion 3.

At Step #11, the control portion 10 makes an output portion an output process for the output image data. For example, various settings for the anonymizing job include selection of the mode of output of the output image data. Different modes include printing and transmission.

If printing is selected as the mode of output, the control portion 10 makes the printing portion 1 print (in other words, output) an image based on the output image data on a sheet S. In this case, the printing portion 1 corresponds to the “output portion” and the output destination is the sheet S.

If transmission is selected as the mode of output, the control portion 10 makes the communication portion 102 transmit (in other words, output) the output image data to the PC 1000. The output image data can be converted into PDF data before being transmitted to the PC 1000. Transmitting the output image data to the PC 1000 permits the output image data to be stored on the PC 1000. In this case, the communication portion 102 corresponds to the “output portion” and the output destination is the PC 1000.

In the embodiment, the operation/display portion 3 accepts an information selection operation and a method selection operation. This permits free selection of personal information to be anonymized and free selection of a method of anonymizing personal information. That is, desired personal information can be anonymized by a desired method. This provides enhanced convenience to the user.

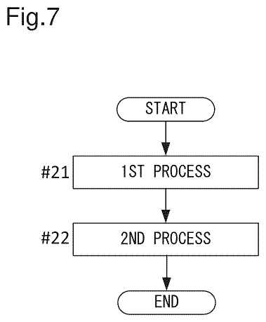

Extracting Personal Information: As the personal information extraction process, the control portion 10 performs a procedure as shown in FIG. 7. The procedure shown in FIG. 7 starts after morpheme analysis is performed on text data extracted from the original image data (i.e., following Step #3).

At Step #21, the control portion 10 performs a first process to extract as personal information a character string that matches a predetermined regular expression. The first process is a process whereby a character string with a predetermined pattern is extracted as personal information.

For example, personal information in the form of a character string with a predetermined pattern can be a telephone number, credit card number, mail address, date (of birth or the like), or time. The predetermined regular expression is determined based on the pattern of at least one (e.g., all) of telephone number, credit card number, mail address, date, and time. Thus, performing the first process achieves extraction of personal information such as a telephone number, credit card number, mail address, date, or time.

At Step #22, using a machine learning model for extraction of a proper noun, the control portion 10 performs a second process to extract as personal information a character string that is supposed to be predetermined information. The machine learning model for the second process is a trained proper noun extraction model and is previously stored in the storage portion 101. The second process takes as its target a proper noun that has not been extracted as personal information in the first process.

The predetermined information is at least one of a character string representing a personal name and a character string representing a geographical name. For example, the predetermined information can be a character string representing a personal name plus a character string representing a geographical name. That is, through the second process a character string representing a personal name and a character string representing a geographical name are extracted as personal information. Accordingly, performing the second process achieves extraction of a personal name and an address as personal information. The predetermined information can be supplemented with character strings representing any other personal information such as domicile of origin, sex, occupation, organization name (like corporate or institutional name), and department.

If the document D shown in FIG. 3 is the target of the anonymizing job, in the first process, character string C1 is extracted as personal information. In the first process, no other character string is extracted as personal information. On the other hand, in the second process, character strings A1, A2, and B1 are extracted as personal information. In the second process, character string C1 is not taken as a target.

In the embodiment, personal information such as telephone number, credit card number, and mail address is extracted in the first process. Then, personal information (name, address, and the like) that cannot be extracted in the first process is extracted in the second process. This helps prevent some personal information from being left unextracted. It is thus possible to prevent personal information that should be anonymized from being left unanonymized.

While the second process uses a learning model, the first process uses none. Personal information such as credit card number and mail address can be extracted in the first process and thus, for example, the second process can be configured to extract only other personal information (such as personal name and address). This helps reduce the calculation cost of the personal information extraction process.

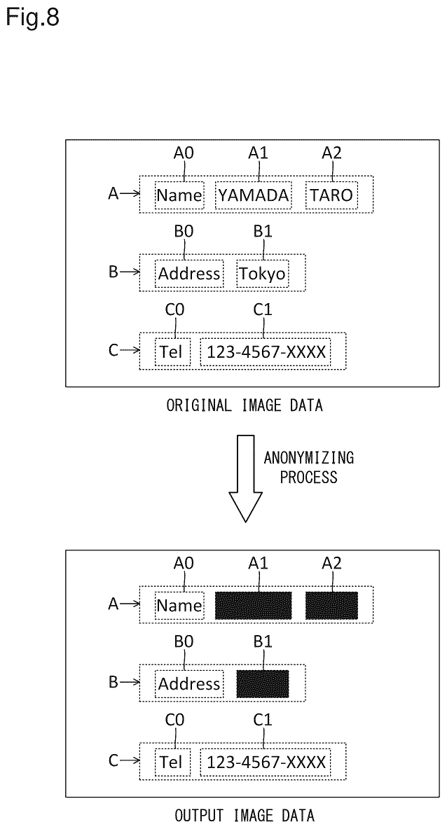

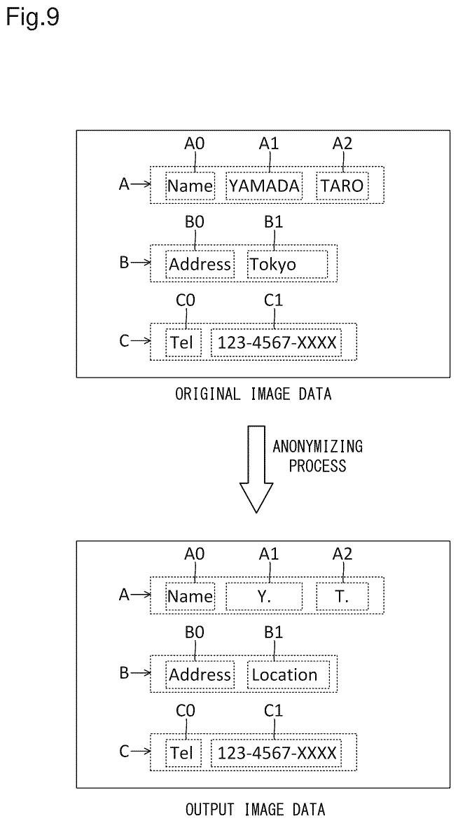

Anonymizing Methods: Now, with reference to FIGS. 8 and 9, three anonymizing methods will be described specifically.

In the examples shown in FIGS. 8 and 9, a region containing character string A1, a region containing character string A2, and a region containing character string B1 are each recognized as a target region. That is, in the information selection operation, personal name (“Name”) and address (“Address”) have been selected.

In the example shown in FIG. 8, blacking-out has been selected as the anonymizing method for each of the region containing character string A1, the region containing character string A2, and the region containing character string B1. That is, in the method selection operation, blacking-out has been selected as the anonymizing method for each of personal name (“Name”) and address (“Address”).

On the other hand, in the example shown in FIG. 9, initial character extraction has been selected as the anonymizing method for each of the region containing character string A1 and the region containing character string A2 and labeling has been selected as the anonymizing method for the region containing character string B1. That is, in the method selection operation, initial character extraction has been selected for personal name (“Name”) and labeling has been selected for address (“Address”).

If the anonymizing method is blacking-out, the control portion 10 performs as the anonymizing process a process of blacking out at least part of the personal information in the target region. For example, at least part of the personal information in the target region is replaced with a solid black image.

In the example shown in FIG. 8, through the anonymizing process, character strings A1 and A2 are blacked out and character string B1 is blacked out.

When the anonymizing method is initial character extraction, the control portion 10 recognizes the initial characters in the character strings constituting the personal information in the target region and performs as the anonymizing method a process of making unrecognizable the characters other than initial characters in the personal information in the target region. For example, if the personal information to be anonymized is a personal name, initial character extraction can be selected as the anonymizing method.

In the example shown in FIG. 9, “Y” in character string A1 and “T” in character string A2 are recognized as initial characters. Thus, in character string A1 the characters following the initial character “Y” are made unrecognizable and in character string A2 the characters following the initial character “T” are made unrecognizable.

For example, as shown in FIG. 9, the character strings constituting a personal name as the personal information in the target region can be replaced with a character string composed of the initial characters in those character strings. Though not shows, the characters other than the initial characters in the character strings constituting a personal name as the personal information in the target region can be blacked out. If the personal name as the personal information in the target region is Japanese, the Japanese personal name can be Romanized into alphabetic character strings and the personal information in the target region can be replaced with a character string composed of the initial characters in those alphabetic character strings.

If the anonymizing method is labeling, the control portion 10 recognizes a labeling character string corresponding to the type of personal information in the target region and performs as the anonymizing process a process of replacing the personal information in the target region with the labeling character string corresponding to its type. Correspondence information that defines correspondence between types of personal information and labeling character strings is previously prepared and stored in the storage portion 101. Based on the correspondence information the control portion 10 recognizes the labeling character string corresponding to the type of the personal information in the target region.

For example, “Address” as one type of personal information is assigned the labeling character string “Location.” Accordingly, in the example shown in FIG. 9, character string B1, “Tokyo”, is replaced with “Location.”

In the embodiment, the three anonymizing methods described above are available as options in the method selection operation. No matter which anonymizing method is used to anonymize personal information, the personal information can be reliably protected.

Editing Output Image Data: Now, with reference to FIGS. 10 to 13, the editing of output image data will be described specifically. The following description assumes the use of blacking-out as a method of anonymizing personal information.

The operation/display portion 3 accepts as the edit operation a first edit operation and a second edit operation. The first edit operation is an operation to specify as the editing target a region in the preview image PG that contains unanonymized personal information. The second edit operation is an operation to specify as the editing target a region in the preview image PG that contains anonymized personal information.

The regions that can be specified in the first and second edit operations are not limited to regions that contain personal information. For example, in the first and second edit operations, an unextracted region, which will be described later, can be specified. The unextracted region is a region that contains a noun character string. The noun character string in the unextracted region can be a character string constituting personal information (proper noun) or a character string constituting any other information (e.g., type of personal information).

The first and second edit operations are both an operation of touching (tapping) a region in the preview image PG. The first and second edit operations can be an operation of touching the region in the preview image PG once (single tap operation), an operation of touching the region in the preview image PG successively twice (double tap operation), or an operation of keeping touching the region in the preview image PG (long tap operation).

When the first edit operation is performed, the control portion 10 judges that the region touched in the first edit operation has been specified as the editing target. When the second edit operation is performed, the control portion 10 judges that the region touched in the second edit operation has been specified as the editing target. Note that the first and second edit operations can be performed each singly or both together.

As shown in FIG. 10, when the first edit operation is performed, the control portion 10 anonymizes the personal information in the region specified in the first edit operation. FIG. 10 shows an example where the region containing character string C1 is specified in the first edit operation. In FIG. 10, the state before the first edit operation is shown at top and the state after the first edit operation is shown at bottom.

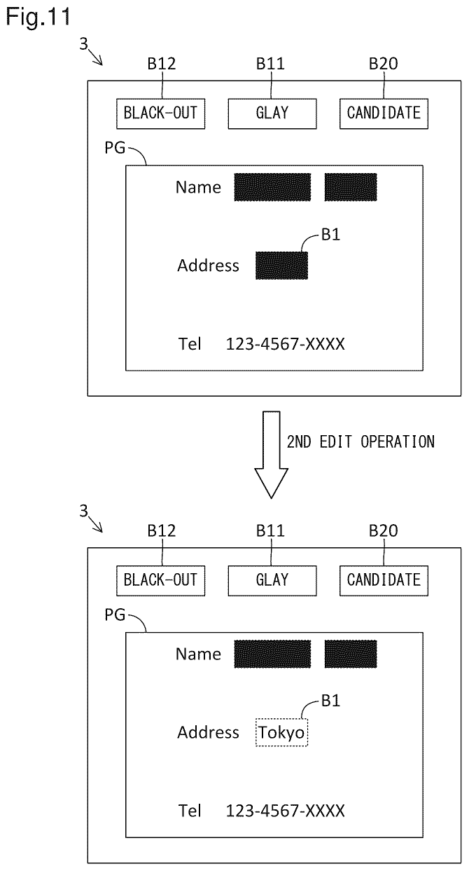

As shown in FIG. 11, when the second edit operation is performed, the control portion 10 restores the personal information in the region specified in the second edit operation as it was before being subjected to the anonymizing process. FIG. 11 shows an example where the region containing character string B 1 is specified in the second edit operation. In FIG. 10, the state before the second edit operation is shown at top and the state after the second edit operation is shown at bottom.

In the embodiment, the operation/display portion 3 displays a preview image PG corresponding to the output image data and accepts an edit operation. To add personal information to be anonymized, the user has only to make a touch operation (i.e., the first edit operation) on the region that contains the personal information. If personal information that does not need anonymizing has been anonymized by mistake, the user has only to make a touch operation (i.e., the second edit operation) on the region that contain the personal information. In this way, the output image data can be edited by simple operation. That is, it is easy to change the personal information to be targeted by anonymizing. This provides enhanced convenience to the user.

For example, due to the low accuracy of the personal information extraction process, character strings that are not personal information, such as character strings A0, B0, and C0 (see FIG. 3), may be extracted and anonymized. In such a case, by performing the second edit operation on the region that contains erroneously anonymized personal information, it is easily possible to unanonymize the personal information.

When accepting an edit operation, the operation/display portion 3 displays, out of the preview image PG, the region containing personal information on an enlarged scale. This makes it easy to specify a region containing personal information in the edit operation.

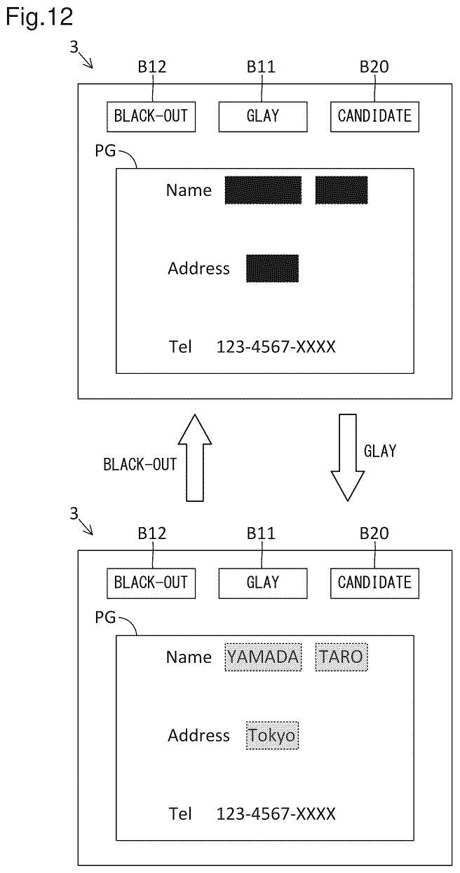

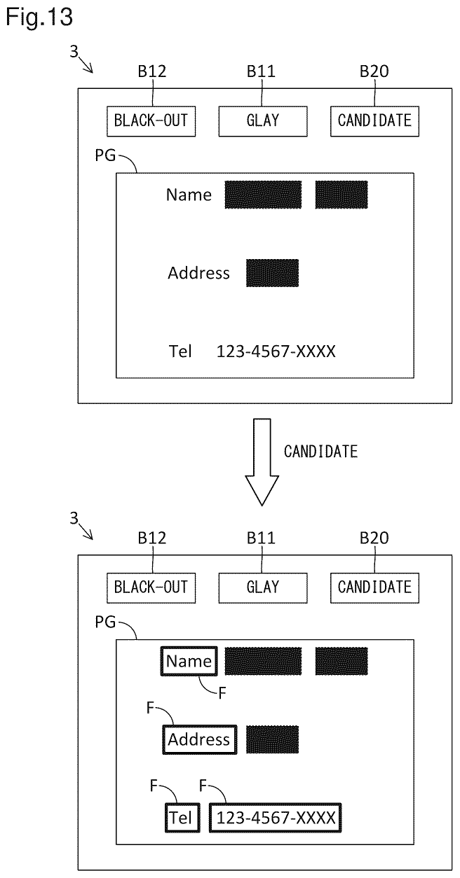

Now, with reference to FIGS. 12 and 13, a description will be given of display screens seen when an edit operation is accepted. For convenience' sake, in FIGS. 12 and 13, the reference signs for character strings are omitted, for which FIG. 3 is to be referred to.

In the embodiment, when an edit operation is accepted, the operation/display portion 3 accepts a display switch operation. On receiving the display switch operation, the operation/display portion 3 displays anonymized personal information in a recognizable manner and accepts an edit operation. Thus the user can perform the edit operation while viewing the anonymized personal information and this provides enhanced convenience to the user.

For example, as shown in FIG. 12, when an edit operation is accepted, the operation/display portion 3 displays, along with a preview image PG, display switch buttons as software buttons. The display switch buttons include a first display switch button B 11 and a second display switch button B12. FIG. 12 shows an example where character strings A1, A2, and B1 are anonymized.

When, with anonymized personal information blacked out to be unrecognizable (the state shown at top in FIG. 12), a touch operation is made on the first display switch button B11, the operation/display portion 3 makes the anonymized personal information recognizable (the state shown at bottom in FIG. 12). In this example, the operation on the first display switch button B 11 correspond to a “display switch operation.”

Operating the first display switch button B11 initiates a process of reducing, compared with the display density of the character strings in the region containing the anonymized personal information, the display density of the background in the region containing the anonymized personal information. For example, the character strings are in black and the background is gray.

On the other hand, when, with anonymized personal information shown recognizable (the state shown at bottom in FIG. 12), a touch operation is made on the second display switch button B12, the operation/display portion 3 blacks out the anonymized personal information to make it unrecognizable (the state shown at top in FIG. 12). The user can then preview the final output result of the output image data, and this is convenient to the user.

Moreover, in the embodiment, when an edit operation is accepted, the operation/display portion 3 accepts a candidate display operation. On accepting the candidate display operation, the operation/display portion 3 highlights an unextracted region that contains a noun character strings unextracted as personal information and accepts an edit operation. When the first edit operation is performed on the unextracted region, the control portion 10 anonymizes the noun character string in the unextracted region.

With this configuration, if due to the low accuracy of the personal information extraction process a noun character string that should be extracted as personal information is not extracted, the noun character string can be recognized easily. If the user wants to anonymize the noun character string, the user can do that by a simple operation of touching an unextracted region as a region that contains the noun character string (i.e., the first edit operation). This provides enhanced convenience to the user.

For example, as shown in FIG. 13, when an edit operation is accepted, the operation/display portion 3 displays, along with a preview image PG, a candidate display button B20 as a software button. When a touch operation is made on the candidate display button B20, the operation/display portion 3 encloses, out of the preview image PG, the region containing a noun character string unextracted as personal information in a frame image F. That is, a transition occurs from the state shown at top in FIG. 13 to the state shown at bottom in FIG. 13. Thus, the unextracted region is highlighted. In this example, the operation on the candidate display button B 20 corresponds to a “candidate display operation.”

There is no particular limitation on the method of highlighting. For example, an image different from the frame image F can be overlaid as a highlighting image on an unextracted region. Or the noun character string in an unextracted region can be displayed in a color (e.g., red) different from that of other character strings, or in bold type.

Here, in the embodiment, when the image reading portion 2 reads a document D, the control portion 10 compares the format of the document D (referred to as the first document D) that the image reading portion 2 reads this time with the format of a document D (referred to the second document D) that the image reading portion 2 read before it reads the first document D. If the formats of the first and second documents D are identical, the control portion 10 reflects in the output image data of the first document D the anonymizing process performed on the output image data of the second document D. Moreover, if the formats of the first and second documents D are identical, the control portion 10 reflects in the output image data of the first document D the editing made in the output image data of the second document D. That is, when the output image data of the first document D is generated, if the formats of the first and second documents D are identical, the control portion 10 anonymizes the same personal information as in the output image data of the second document D.

For example, each time the control portion 10 reads a document D, it generates format information that indicates the format of the read document D. Moreover, each time the control portion 10 generates output image data, it generates anonymized information that indicates anonymized personal information and stores in the storage portion 101 the format information and the anonymized information associated with each other.

Then, based on the format information on each of the first and second documents D, the control portion 10 checks whether the formats of the first and second documents D are identical. Moreover, based on the anonymized information corresponding to the second document D, the control portion 10 recognizes the personal information anonymized when the output image data of the second document D was generated. In this way, in the output image data of the first document D and the output image data of the second document D, the same personal information is anonymized.

With this configuration, when the user wants to anonymize in the first document D the same type of personal information as the personal information anonymized in the second document D, the user can without fail anonymize the desired personal information without performing an edit operation on the output image data of the first document D. This provides enhanced convenience to the user.

The embodiment disclosed herein should be understood to be in every aspect illustrative and not restrictive. The scope of the present disclosure is defined not by the description of the embodiment given above but by the appended claims and encompasses any modifications made within a scope equivalent in significance to those claims.

What is claimed is:

1. An image processing apparatus comprising:
an image reading portion that reads a document containing personal information;
a control portion that performs an anonymizing process on original image data acquired through reading of the document by the image reading portion, the control portion thereby generating output image data in which the personal information is anonymized; and
a operation/display portion that displays information and that accepts an operation,
wherein
the operation/display portion accepts
an information selection operation for selecting the personal information to be anonymized and
a method selection operation for selecting an anonymizing method for the personal information,
when generating the output image data, the control portion
extracts text data by an OCR process on the original image data,
extracts the personal information from the text data,
recognizes as a target region a region of the original image data that contains the personal information selected by the information selection operation, and
performs as the anonymizing process a process of anonymizing the personal information in the target region by the method selected by the method selection operation.

2. The image processing apparatus according to claim 1, wherein
the control portion performs a first process and a second process as a process of extracting the personal information from the text data,
the first process is a process of extracting as the personal information a character string corresponding to a predetermined regular expression, and
the second process is a process of extracting as the personal information a character string supposed to indicate predetermined information by using a machine learning model for extracting a proper noun.

3. The image processing apparatus according to claim 2, wherein
the regular expression is previously determined based on at least one of character string patterns of telephone number, credit card number, mail address, date, and time.

4. The image processing apparatus according to claim 2, wherein
the predetermined information at least includes a personal name and a geographical name.

5. The image processing apparatus according to claim 1, wherein
the operation/display portion accepts as the method selection operation an operation to select one of blacking-out, initial character extraction, and labeling,
when blacking-out is selected, the control portion performs as the anonymizing process a process of blacking out the personal information in the target region,
when initial character extraction is selected, the control portion performs as the anonymizing process a process of making unrecognizable any character other than an initial character in a character string constituting the personal information in the target region, and
when labeling is selected, the control portion performs as the anonymizing process a process of recognizing a labeling character string associated with a type of the personal information in the target region and replacing the personal information in the target region with the labeling character string.

6. The image processing apparatus according to claim 1, further comprising:
an output portion that performs an output process for the output image data,
wherein
the output portion is at least either
a printing portion that, as the output process, prints an image based on the output image data on a sheet and
a communication portion that, as the output process, transmits the output image data to an external device.
